(19) United States
(12) Patent Application Publication
(10) Pub. No.: US 2013/0307646 A1
(43) Pub. Date: Nov. 21, 2013

(54) Adaptive Equalization of Impedance Mismatched Card-Edge Connections

(71) Applicants: Steve Hopkins, Union City, CA (US); Brian Ishaug, Pleasanton, CA (US); Zulfikar Morbi, San Jose, CA (US); Oleh Sniezko, Highlands Ranch, CO (US)

(72) Inventors: Steve Hopkins, Union City, CA (US); Brian Ishaug, Pleasanton, CA (US); Zulfikar Morbi, San Jose, CA (US); Oleh Sniezko, Highlands Ranch, CO (US)

(21) Appl. No.: 13/672,712

(22) Filed: Nov. 9, 2012

Related U.S. Application Data
(60) Provisional application No. 61/628,933, filed on Nov. 9, 2011.

(51) Int. Cl. H04B 3/14

(52) U.S. Cl. CPC H04B 3/14
USPC 333/28 R

(57) ABSTRACT

A method includes tapping power from a broadband RF input, filtering the tapped power with a plurality of band pass filters, measuring the power filtered by each of the plurality of band pass filters and controlling an adaptive equalizer circuit to flatten excessive non-linear frequency response from the broadband RF input as a function of measured power filtered at each of the plurality of band pass filters. An apparatus, includes a broadband RF input, a plurality of band pass filters coupled to the broadband RF input, at least one power measurement circuit coupled to the plurality of band pass filters and an adaptive equalizer circuit coupled to the at least one power power measurement circuit and the plurality of band pass filters, wherein the at least one power measurement circuit provides control signals to the adaptive equalizer circuit as a function of measured power at each of the plurality of band pass files and wherein the adaptive equalizer circuit flattens excessive non-linear frequency response of the broadband RF input.

### CROSS-REFERENCES TO RELATED APPLICATION(S)

This application claims a benefit of priority under 35 U.S.C. 119(e) from copending provisional patent applications U.S. Ser. No. 61/628,933, filed Nov. 9, 2011, U.S. Ser. No. 61/628,923, filed Nov. 9, 2011, U.S. Ser. No. 61/629,030, filed Nov. 10, 2011, U.S. Ser. No. 61/629,029, filed Nov. 10, 2011 and U.S. Ser. No. 61/629,028, filed Nov. 10, 2011, the entire contents of all of which are hereby expressly incorporated herein by reference for all purposes.

### BACKGROUND

Broadband communication systems are complex systems with many factors to consider when designing RF circuits and connectors. Usually one has to use specialized connectors in a coaxial form-factor with proper shielding in order to mate RF connections between boards or modules. A problem arises when there is not enough physical space to utilize these RF connectors and you have to use connection methods that were not designed for broadband RF signals. One of the issues with using these types of non-RF connections is poor impedance matching that can vary each time the connections are made.

### SUMMARY

There is a need for the following embodiments of the present disclosure. Of course, the present disclosure is not limited to these embodiments.

According to an embodiment of the present disclosure, a process comprises: tapping power from a broadband RF input, filtering the tapped power with a plurality of band pass filters, measuring the power filtered by each of the plurality of band pass filters and controlling an adaptive equalizer circuit to flatten excessive non-linear frequency response from the broadband RF input as a function of measured power filtered at each of the plurality of band pass filters. According to another embodiment of the present disclosure, a machine comprises: a broadband RF input, a plurality of band pass filters coupled to the broadband RF input, at least one power measurement circuit coupled to the plurality of band pass filters and an adaptive equalizer circuit coupled to the at least one power power measurement circuit and the plurality of band pass filters, wherein the at least one power measurement circuit provides control signals to the adaptive equalizer circuit as a function of measured power at each of the plurality of band pass files and wherein the adaptive equalizer circuit flattens excessive non-linear frequency response of the broadband RF input.

These, and other, embodiments of the present disclosure will be better appreciated and understood when considered in conjunction with the following description and the accompanying drawings. It should be understood, however, that the following description, while indicating various embodiments of the present disclosure and numerous specific details thereof, is given for the purpose of illustration and does not imply limitation. Many substitutions, modifications, additions and/or rearrangements may be made within the scope of embodiments of the present disclosure, and embodiments of the present disclosure include all such substitutions, modifications, additions and/or rearrangements.

### BRIEF DESCRIPTION OF THE DRAWINGS

The drawings accompanying and forming part of this specification are included to depict certain embodiments of the present disclosure. A clearer concept of the embodiments described in this application will be readily apparent by referring to the exemplary, and therefore nonlimiting, embodiments illustrated in the drawings (wherein identical reference numerals (if they occur in more than one view) designate the same elements). The described embodiments may be better understood by reference to one or more of these drawings in combination with the following description presented herein. It should be noted that the features illustrated in the drawings are not necessarily drawn to scale.

FIG. 1 is block schematic view of a PCB card-edge connector mating with a card-edge style connector and adaptive equalizing circuit, representing an embodiment of the present disclosure.

FIG. 2 is block schematic view of an adaptive equalizing circuit, representing an embodiment of the present disclosure.

### DETAILED DESCRIPTION

Embodiments presented in the present disclosure and the various features and advantageous details thereof are explained more fully with reference to the nonlimiting embodiments that are illustrated in the accompanying drawings and detailed in the following description. Descriptions of well known signal processing techniques, components and equipment are omitted so as not to unnecessarily obscure the embodiments of the present disclosure in detail. It should be understood, however, that the detailed description and the specific examples are given by way of illustration only and not by way of limitation. Various substitutions, modifications, additions and/or rearrangements within the scope of the underlying inventive concept will become apparent to those skilled in the art from this disclosure.

Embodiments of the invention relate to transmission of analog and/or digital signals over fiber optics. More specifically, some embodiments of the invention relate to small form factor pluggable modules for transmission systems such as, but not limited to, CATV systems. The disclosure of this application is marginally related to copending U.S. Ser. No(s). ______ (attorney docket number AUROR1360-1), filed Nov. 9, 2012, ______ (attorney docket number AUROR1370-1), filed Nov. 9, 2012, ______ (attorney docket number AUROR1380-1), filed Nov. 9, 2012, ______ (attorney docket number AUROR1390-1), filed Nov. 9, 2012, the entire contents of all of which are hereby expressly incorporated by reference for all purposes.

Embodiments of the invention enable the repair the symptoms of a poorly miss-matched connection so that cheaper and smaller form-factor connections can be utilized, such as, but not limited to a PCB card-edge connector mating pair.

Embodiments of the invention can include an adaptive equalizer circuit. Such an adaptive equalizer circuit enables a way to fix the excessive non-linear frequency response problems associated with poor impedance miss-matching while using connectors that were not designed specifically for the job of connecting broadband RF signals.

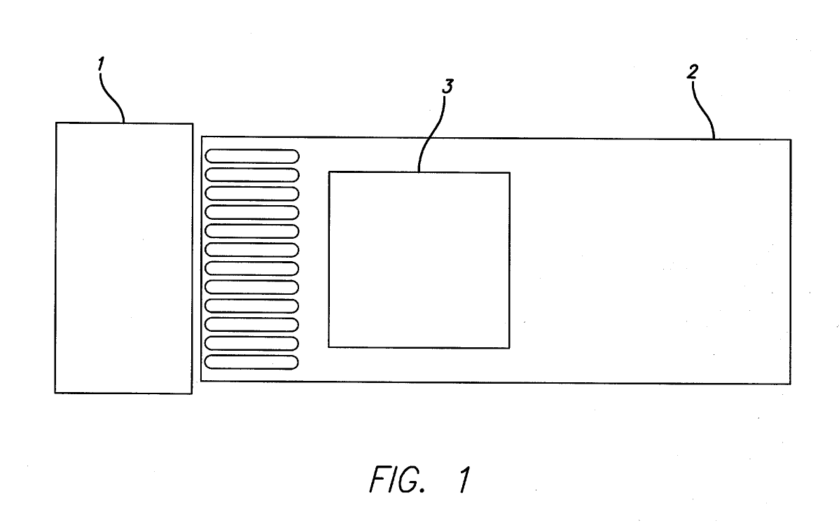

Referring to FIG. 1, a PCB card-edge connector 2 is shown mating with a card-edge style connector 1. The PCB card-edge connector 2 includes an adaptive equalizing circuit 3. This type of card-edge connector was not specifically designed for broadband analog RF transmissions and will have poor impedance matching characteristics. The end result will be a non-flat frequency response. For example, with improper impedance matching the low frequency signals may have higher amplitude than the higher frequency signals. Also, the impedance may change between mating cycles adding a new variable.

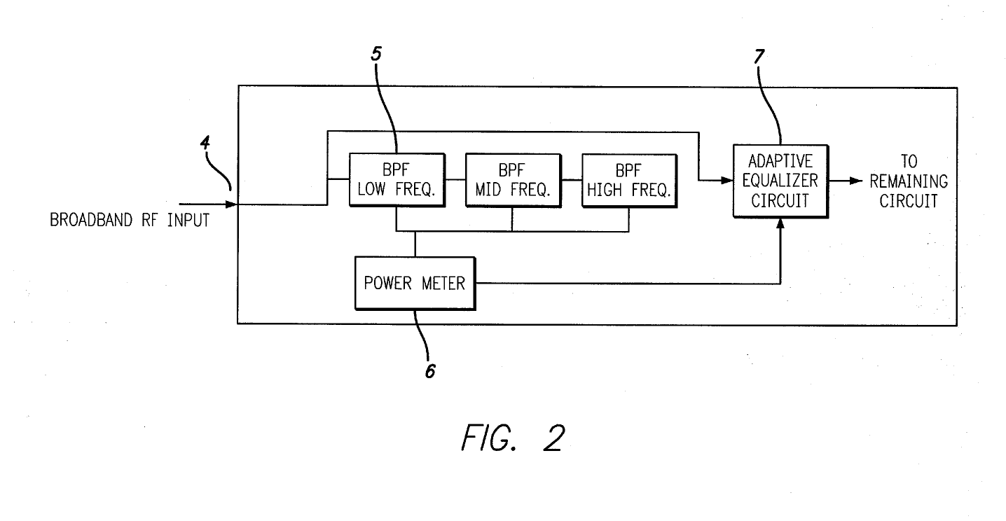

Embodiments of the invention described here will allow the use of existing connectors not designed for RF with PCB card-edge mating; and will adapt to the variations one can get with various mating cycles. Referring to FIG. 2, the broadband RF input 4 injected to the PCB card-edge connection from the connector can be tapped off and injected to a plurality of band pass filters (BPF) 5 and a (plurality of) internal power measurement circuit(s) 6. The power measurement circuit(s) may include a microcontroller or logic circuit that can provide control signals to the adaptive equalizer circuits. The power measurement/control circuit can measure and then make adjustments to an adaptive equalizer circuit 7 in order to flatten the otherwise poor frequency response. The number of band pass filters can vary from the example shown in FIG. 2 to give a finer resolution if necessary to adjust the incoming broadband RF input 4 signal appropriately.

### Definitions

The terms program and/or software and/or the phrases computer program and/or computer software are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system). The phrase radio frequency (RF) is intended to mean frequencies less than or equal to approximately 300 GHz as well as the infrared spectrum.

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this present disclosure belongs. In case of conflict, the present specification, including definitions, will control.

The described embodiments and examples are illustrative only and not intended to be limiting. Although embodiments of the present disclosure can be implemented separately, embodiments of the present disclosure may be integrated into the system(s) with which they are associated. All the embodiments of the present disclosure disclosed herein can be made and used without undue experimentation in light of the disclosure. Embodiments of the present disclosure are not limited by theoretical statements (if any) recited herein. The individual steps of embodiments of the present disclosure need not be performed in the disclosed manner, or combined in the disclosed sequences, but may be performed in any and all manner and/or combined in any and all sequences. The individual components of embodiments of the present disclosure need not be combined in the disclosed configurations, but could be combined in any and all configurations.

Various substitutions, modifications, additions and/or rearrangements of the features of embodiments of the present disclosure may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising:
tapping power from a broadband RF input,
filtering the tapped power with a plurality of band pass filters,
measuring the power filtered by each of the plurality of band pass filters and
controlling an adaptive equalizer circuit to flatten excessive non-linear frequency response from the broadband RF input as a function of measured power filtered at each of the plurality of band pass filters.

2. The method of claim 1, further comprising conveying a broadband RF signal from a PCB card-edge connector mating pair to the broadband RF input before tapping power from the broadband RF input.

3. An apparatus, comprising:
a broadband RF input,
a plurality of band pass filters coupled to the broadband RF input,
at least one power measurement circuit coupled to the plurality of band pass filters and
an adaptive equalizer circuit coupled to the at least one power power measurement circuit and the plurality of band pass filters,
wherein the at least one power measurement circuit provides control signals to the adaptive equalizer circuit as a function of measured power at each of the plurality of band pass files and
wherein the adaptive equalizer circuit flattens excessive non-linear frequency response of the broadband RF input.

4. The apparatus of claim , wherein the at least one power measurement circuit includes at least one microcontroller or logic circuit to provide control signals to the adaptive equalizer circuit.

5. The apparatus of claim , wherein the plurality of band pass filters are connected in a single series between the broadband RF input and the adaptive equalizer circuit.

6. The apparatus of claim , wherein the at least one power measurement circuit includes a plurality of power measurement circuits, each of the plurality of power measurement circuits coupled to one of the plurality of band pass filters.

7. The apparatus of claim , further comprising a PCB card-edge connector mating pair coupled to the broadband RF input.
